(19) United States
(12) Patent Application Publication
(10) Pub. No.: US 2007/0260015 A1
(43) Pub. Date: Nov. 8, 2007

(54) Thermoplastic Molding Compounds with Improved Properties with Regard to Flow and Demolding

(75) Inventors: Martin Stork, Mannheim (DE); Bernd Bruchmann, Freinsheim (DE); Andreas Eipper, Ludwigshafen (DE); Norbert Niessner, Friedelsheim (DE); Graham Edmund McKee, Neustadt (DE); Martin Weber, Maikammer (DE); Axel Gottschalk, Neustadt (DE); Sven Riechers, Randolph Township, NJ (US); Jean-Francois Stumbe, Strasbourg (FR)

Correspondence Address: CONNOLLY BOVE LODGE & HUTZ, LLP, P O BOX 2207, WILMINGTON, DE, 19899, US

(73) Assignee: BASF Aktiengesellschaft, Ludwigshafen (DE)

(21) Appl. No.: 11/659,771

(22) PCT Filed: Aug. 9, 2005
(86) PCT No.: PCT/EP05/08607

§ 371 Date: Feb. 8, 2007

(30) Foreign Application Priority Data
Aug. 10, 2004 (DE) 10 2004 038 978.0
Dec. 8, 2004 (DE) 10 2004 059 243.8

(51) Int. Cl. C08L 33/12

(52) U.S. Cl. 525/220; 525/221; 525/227

(57) ABSTRACT

Thermoplastic molding compositions comprising a mixture of a component (A), a component (B), a component (C) and a component (D), methods for their preparation and use, and mold-release agents for thermoplastic molding compositions: wherein the component (A) comprises a methyl methacrylate polymer; wherein the component (B) comprises a copolymer prepared by polymerizing from 75 to 88% by weight of a vinylaromatic monomer and from 12 to 25% by weight of a vinyl cyamide; wherein the component (C) comprises a graft copolymer prepared by copolymerizing: from 60 to 90% by weight, based on component (C), of a core, from 5 to 20% by weight, based on component (C), of a first graft shell, and from 5 to 20% by weight, based on component (C), of a second graft shell; and wherein the component (D) comprises at least one highly branched or hyperbranched polymer selected from the group consisting of (D1) highly branched or hyperbranched polycarbonates, (D2) highly branched or hyperbranched polyesters of Aₓ+B_{y} type, where x is at least 1.1 and y is at least 2.1, and mixtures thereof.

The present invention relates to thermoplastic molding compositions comprising a mixture composed of
(A) 30 to 68.99% by weight, based on the entirety of components (A), (B), (C), and (D) of a methyl methacrylate polymer, obtainable via polymerization of a mixture, composed of
   (A1) from 90 to 100% by weight, based on (A), of methyl methacrylate, and
   (A2) from 0 to 10% by weight, based on (A), of a C₁-C₈-alkyl acrylate, and
(B) 30 to 68.99% by weight, based on the entirety of components (A), (B), (C), and (D) of a copolymer, obtainable via polymerization of a mixture, composed of
   (B1) from 75 to 88% by weight, based on (B), of a vinylaromatic monomer, and
   (B2) from 12 to 25% by weight, based on (B), of a vinyl cyamide
      and
(C) from 1 to 39.99% by weight, based on the entirety of components (A), (B), (C), and (D), of a graft copolymer, obtainable from
   (C1) from 60 to 90% by weight, based on (C), of a core, obtainable via polymerization of a monomer mixture, composed of
      (C11) from 65 to 90% by weight, based on (C1), of a 1,3-diene, and
      (C12) from 10 to 35% by weight, based on (C1), of a vinylaromatic monomer,
         and
   (C2) from 5 to 20% by weight, based on (C), of a first graft shell, obtainable via polymerization of a monomer mixture, composed of
      (C21) from 30 to 60% by weight, based on (C2), of a vinylaromatic monomer,
      (C22) from 40 to 70% by weight, based on (C2), of a C₁-C₈-alkyl methacrylate, and
      (C23) from 0 to 3% by weight, based on (C2), of a crosslinking monomer,
         and
   (C3) from 5 to 20% by weight, based on (C), of a second graft shell, obtainable via polymerization of a monomer mixture, composed of
      (C31) from 70 to 98% by weight, based on (C3), of a C₁-C₈-alkyl methacrylate, and
      (C32) from 2 to 30% by weight, based on (C3), of a C₁-C₈-alkyl acrylate,
with the proviso that the ratio by weight of (C2) to (C3) is in the range from 2:1 to 1:2,
   and
   (D) from 0.01 to 39% by weight, based on the entirety of components (A), (B), (C), and (D), of at least one highly branched or hyperbranched polymer, selected from the group of
   (D1) highly branched or hyperbranched polycarbonates, and
   (D2) highly branched or hyperbranched polyesters of Aₓ+B_{y} type, where x is at least 1.1 and y is at least 2.1,
      and
(E) if appropriate, amounts of up to 20% by weight, based on the entirety of components (A), (B), (C), and (D), of conventional additives.

The invention further relates to a process for preparation of the inventive thermoplastic molding compositions, to their use, and to the moldings, fibers, foils, or foams obtainable therefrom, and also to mold-release agents for thermoplastic molding compositions.

WO 97/08241 discloses molding compositions which are composed of a hard methyl methacrylate polymer, of a hard vinylaromatic-vinyl cyamide polymer, and of a soft graft copolymer comprising an elastomeric graft core, a first graft shell composed of a vinylaromatic-alkyl methacrylate polymer, and a second graft shell composed of an alkyl(meth)acrylate polymer. These molding compositions feature good impact resistance, high flowability, high light transmittance, very low light scattering, and very little yellow tinge at their edges. However, the flowability and mold-release properties of these molding compositions still require improvement for some application sectors.

Improved flowability is usually achieved via addition of polymers with low molecular weight, or of oligomers. However, the result is often marked impairment of mechanical properties, softening point (Vicat), and optical properties, such as transparency.

Dendritic polymers having a perfectly symmetrical structure, known as dendrimers, can be prepared starting from one central molecule via controlled stepwise linkage of, in each case, two or more di- or polyfunctional monomers to each previously bonded monomer. Each linkage step here exponentially increases the number of monomer end groups (and thus of linkages), and this gives polymers with dendritic structures, in the ideal case spherical, the branches of which comprise exactly the same number of monomer units. This perfect structure provides advantageous polymer properties, and by way of example surprisingly low viscosity is found, as is high reactivity, due to the large number of functional groups on the surface of the sphere. However, the preparation process is complicated by the fact that protective groups have to be introduced and in turn removed again during each linkage step, and purification operations are required, the result being that it is usual for dendrimers to be prepared only on a laboratory scale.

However, highly branched or hyperbranched polymers can be prepared using industrial processes. They also have linear polymer chains and unequal polymer branches alongside perfect dendritic structures, but this does not substantially impair the properties of the polymer when comparison is made with perfect dendrimers. Hyperbranched polymers can be prepared via two synthetic routes known as AB₂ and Aₓ+B_{y}. Aₓ and B_{y} here are different monomers and the indices x and y are the number of functional groups present in A and B respectively, i.e. the functionality of A and B, respectively. In the AB₂ route, a trifunctional monomer having a reactive group A and having two reactive groups B is reacted to give a highly branched or hyperbranched polymer. In the Aₓ+B_{y} synthesis, taking the example of A₂+B₃ synthesis, a difunctional monomer A₂ is reacted with a trifunctional monomer B₃. This first gives a 1:1 adduct composed of A and B having an average of one functional group A and two functional groups B, and this then can likewise react to give a highly branched or hyperbranched polymer.

WO 97/45474 describes polymer mixtures composed of hyperbranched dendritic polyesters and of other thermoplastics, such as polystyrene or ABS (acrylonitrile-butadiene-sytrene copolymer), where both components bear particular functional groups capable of graft reactions. This functionalization of the thermoplastic takes place in a separate step via grafting of an unsaturated monomer onto the thermoplastic.

WO 96/11962 describes non-linear monovinylaromatic polymers with a comb structure, star structure, or dendritic structure, having from 1 to 4 branching points. The polymers may comprise rubbers; however, there is no description of mixtures of the polymers with conventional linear styrene copolymers, such as SAN (styrene-acrylonitrile copolymer).

Gorda et al., in Journal of Applied Polymer Science 1993, vol. 50, pages 1977-1983, describe mixtures composed of SAN and of star-shaped polymers composed of ε-caprolactone. Star-shaped polymers differ fundamentally from dendritic or hyperbranched polymers: in dendritic and hyperbranched polymers the number of branching sites increases exponentially as distance from the center increases, i.e. the number of branches in the polymer rises greatly toward the outside. In contrast, star polymers have unbranched arms, i.e. the functionality of the central molecule determines the number of arms in the star. In relation to this distinction, see also pages 7-8 of the abovementioned WO 97/45474 and in particular the formulae (III) to (VI) in that publication.

EP-A 545184 describes linear, star-shaped, or dendritic block copolymers composed of acrylic esters and of methacrylic esters, e.g. methyl methacrylate (MMA), and their mixtures with, inter alia, SAN. The block copolymers are prepared via the highly water-sensitive group transfer polymerization (GTP) process. Dendritic polymers without a block structure are not mentioned.

Sunder et al. in Macromolecules 2000, 33, pages 1330-1337, disclose hyperbranched polyglycerols esterified with carboxylic acids. Mixtures of these polymers with styrene copolymers are not mentioned.

DE-A 43 28 004 describes thermoplastic block copolymers with star-shaped radially arranged arms, and their mixtures with, inter alia, SAN, ABS or ASA (acrylonitrile-styrene-acrylate copolymer). These block copolymers, too, are prepared via group transfer polymerization (GTP), which requires rigorous exclusion of moisture. Dendritic polymers without a block structure are not mentioned.

The patent applications DE 102004 005652.8 and DE 102004 005657.9, both of Feb. 4, 2004, these not being prior publications, propose new flow improvers for polyesters.

An object underlying the present invention was therefore to provide thermoplastic molding compositions which are based on hard methyl methacrylate polymers, on hard vinylaromatic-vinyl cyamide polymers and on soft graft copolymers, and which have improved flowability while mechanical and optical properties are comparable. The flow improver should be easy to prepare. The thermoplastic molding compositions should moreover have improved demoldability, for example during production of moldings, in order to permit increased throughput or reduce production costs.

Accordingly, the thermoplastic molding compositions defined at the outset and comprising component (D) have been found.

A process for their preparation has also been found, as has their use for production of moldings, of fibers, of foils, or of foams, and also moldings, fibers, foils, or foams comprising the inventive thermoplastic molding compositions.

Mold-release agents for thermoplastic molding compositions have also been found.

The inventive thermoplastic molding compositions, processes, uses, and moldings, fibers, foils, or foams are described below, as also are the mold-release agents.

The inventive thermoplastic molding compositions comprise
(A) 30 to 68.99% by weight, preferably from 32.5 to 57.0% by weight, based in each case on the entirety of components (A), (B), (C), and (D) of a methyl methacrylate polymer, obtainable via polymerization of a mixture, composed of
   (A1) from 90 to 100% by weight, preferably from 92 to 98% by weight, based in each case on (A), of methyl methacrylate, and
   (A2) from 0 to 10% by weight, preferably from 2 to 8% by weight, based in each case on (A), of a C₁-C₈-alkyl acrylate
(B) 30 to 68.99% by weight, preferably from 32.5 to 57.0% by weight, based in each case on the entirety of components (A), (B), (C), and (D) of a copolymer, obtainable via polymerization of a mixture, composed of
   (B1) from 75 to 88% by weight, preferably from 79 to 85% by weight, based in each case on (B), of a vinylaromatic monomer, and
   (B2) from 12 to 25% by weight, preferably from 15 to 21% by weight, based in each case on (B), of a vinyl cyamide
      and
(C) from 1 to 39.99% by weight, preferably from 10 to 34.5% by weight, based in each case on the entirety of components (A), (B), (C), and (D), of a graft copolymer, obtainable from
   (C1) from 60 to 90% by weight, preferably from 70 to 80% by weight, based in each case on (C), of a core, obtainable via polymerization of a monomer mixture, composed of
      (C11) from 65 to 90% by weight, preferably from 70 to 85% by weight, based in each case on (C1), of a 1,3-diene, and
      (C12) from 10 to 35% by weight, preferably from 15 to 30% by weight, based in each case on (C1), of a vinylaromatic monomer,
   and
   (C2) from 5 to 20% by weight, preferably from 10 to 15% by weight, based in each case on (C), of a first graft shell, obtainable via polymerization of a monomer mixture, composed of
      (C21) from 30 to 60% by weight, preferably from 30 to 39% by weight, particularly preferably from 31 to 35% by weight, based in each case on (C2), of a vinylaromatic monomer,
      (C22) from 40 to 70% by weight, preferably from 61 to 70% by weight, particularly preferably from 63 to 68% by weight, based in each case on (C2), of a C₁-C₈-alkyl methacrylate, and
      (C23) from 0 to 3% by weight, preferably from 0 to 2% by weight, particularly preferably from 1 to 2% by weight, based in each case on (C2), of a crosslinking monomer,
   and
   (C3) from 5 to 20% by weight, preferably from 10 to 15% by weight, based in each case on (C), of a second graft shell, obtainable via polymerization of a monomer mixture, composed of
      (C31) from 70 to 98% by weight, preferably from 75 to 92% by weight, based in each case on (C3), of a C₁-C₈-alkyl methacrylate, and
      (C32) from 2 to 30% by weight, preferably from 8 to 25% by weight, based in each case on (C3), of a C₁-C₈-alkyl acrylate,
   with the proviso that the ratio by weight of (C2) to (C3) is in the range from 2:1 to 1:2,
      and
(D) from 0.01 to 39% by weight, preferably from 0.5 to 10% by weight, based in each case on the entirety of components (A), (B), (C), and (D), of at least one highly branched or hyperbranched polymer, selected from the group of
   (D1) highly branched or hyperbranched polycarbonates, and
   (D2) highly branched or hyperbranched polyesters of Aₓ+B_{y} type, where x is at least 1.1 and y is at least 2.1,
      and
(E) if appropriate, amounts of from 0 to 20%, preferably from 0 to 10% by weight, based in each case on the entirety of components (A), (B), (C), and (D), of conventional additives.
   Component (A)

The methyl methacrylate polymers (A) used in the inventive thermoplastic molding compositions are either homopolymers composed of methyl methacrylate (MMA) or copolymers composed of MMA with up to 10% by weight, based on (A), of a C₁-C₈-alkyl acrylate.

The C₁-C₈-alkyl acrylate (component A2) used may be methyl acrylate, ethyl acrylate, propyl acrylate, n-butyl acrylate, n-pentyl acrylate, n-hexyl acrylate, n-heptyl acrylate, n-octyl acrylate or 2-ethylhexyl acrylate, or else a mixture thereof, preferably methyl acrylate, ethyl acrylate, n-butyl acrylate, 2-ethylhexyl acrylate, or a mixture thereof, particularly preferably methyl acrylate.

The methyl methacrylate (MMA) polymers may be prepared via bulk, solution, or bead polymerization, by known methods (see, for example, Kunststoff-Handbuch [Plastics handbook], volume IX, “Polymethacrylates”, Vieweg/Esser, Carl-Hanser-Verlag 1975) and are commercially available. It is preferable to use methyl methacrylate polymers whose weight-average M_{w} molar mass values are in the range from 60 000 to 300 000 g/mol (determined via light scattering in chloroform).

Component (B)

Component (B) is a copolymer composed of a vinylaromatic monomer (B1) and vinyl cyamide (B2).

Vinylaromatic monomers (component B1) which may be used are styrene, and styrene substituted with from one to three C₁-C₈-alkyl radicals e.g. p-methylstyrene or tert-butyl-styrene, and also α-methylstyrene, but preferably styrene.

The vinyl cyamide (component B2) used may comprise acrylonitrile and/or methacrylonitrile, preferably acrylonitrile.

Outside the range stated above for the constitution of component (B), the usual result at processing temperatures above 240° C. is cloudy molding compositions which have streaks.

The copolymers (B) may be prepared by known processes, e.g. via bulk, solution, suspension or emulsion polymerization, preferably via solution polymerization (see GB-A 14 72 195). Preference is given here to copolymers (B) with molar masses M_{w} of from 60 000 to 300 000 g/mol, determined via light scattering in dimethylformamide.

Component (C)

The component (C) used comprises a graft copolymer composed of a core (C1) and of two graft shells (C2) and (C3) applied thereto.

The core (C1) is the graft base and has a swelling index SI of from 15 to 50, in particular from 20 to 40, determined by measuring swelling in toluene at room temperature.

The 1,3-diene (component C11) used for the core of the graft copolymer (component C1) may comprise butadiene and/or isoprene.

The vinylaromatic monomer (component C12) used may comprise styrene or preferably styrene substituted on the ring with one C₁-C₈-alkyl group, preferably in the α-position, or else with two or more C₁-C₈-alkyl groups, preferably methyl.

The core of the graft copolymer preferably has a glass transition temperature below 0° C. The average particle size of the core is in the range from 30 to 250 nm, particularly preferably in the range from 50 to 180 nm. The core is usually prepared via emulsion polymerization (see, by way of example, Encyclopedia of Polymer Science and Engineering, vol. 1, pp. 401 et seq.).

The graft shell (C2), which comprises the monomers (C21), (C22), and, if appropriate, (C23), is applied to the core (C1).

The vinylaromatic monomer (component C21) used may comprise styrene or preferably styrene substituted on the ring with one C₁-C₈-alkyl group, preferably in the α-position, or else with two or more C₁-C₈-alkyl groups, preferably methyl.

The C₁-C₈-alkyl methacrylate (component C22) used according to the invention comprises methyl methacrylate (MMA), ethyl methacrylate, n-propyl methacrylate, isopropyl methacrylate, n-butyl methacrylate, isobutyl methacrylate, sec-butyl methacrylate, tert-butyl methacrylate, pentyl methacrylate, hexyl methacrylate, heptyl methacrylate, octyl methacrylate, or 2-ethylhexyl methacrylate, of which methyl methacrylate is particularly preferred, and also mixtures of these monomers.

Monomer (C23) which may be used comprise conventional crosslinking monomers, i.e. in essence di- or polyfunctional comonomers, in particular alkylene glycol di(meth)acrylates, such as ethylene glycol di(meth)acrylate, propylene glycol di(meth)-acrylate, and butylene glycol di(meth)acrylate, allyl methacrylate, (meth)acrylates of glycerol, trimethylolpropane, pentaerythritol, or vinylbenzenes, such as di- or trivinylbenzene. Preference is given to use of butylene glycol dimethacrylate, butylene glycol diacrylate, and dihydrodicyclopentadienyl acrylate in the form of an isomer mixture, particularly dihydrodicyclopentadienyl acrylate in the form of an isomer mixture.

A further graft shell (C3), which comprises the monomers (C31) and (C32), is in turn applied to the graft shell (C2). The monomers (C31) are C₁-C₈-alkyl methacrylates, and the monomers (C32) are C₁-C₈-alkyl acrylates.

The C₁-C₈-alkyl methacrylates (monomers C31) used according to the invention are methyl methacrylate (MMA), ethyl methacrylate, n-propyl methacrylate, isopropyl methacrylate, n-butyl methacrylate, isobutyl methacrylate, sec-butyl methacrylate, tert-butyl methacrylate, pentyl methacrylate, hexyl methacrylate, heptyl methacrylate, octyl methacrylate, or 2-ethylhexyl methacrylate, of which methyl methacrylate is particularly preferred, and also mixtures of these monomers.

C₁-C₈-alkyl acrylate (monomers C32) which may be used comprise methyl acrylate (MA), ethyl acrylate, propyl acrylate, n-butyl acrylate, isobutyl acrylate, sec-butyl acrylate, tert-butyl acrylate, pentyl acrylate, hexyl acrylate, heptyl acrylate, octyl acrylate, or 2-ethylhexyl acrylate, among which methyl acrylate is particularly preferred, and also mixtures of these monomers with one another.

The two graft shells (C2) and (C3) are prepared in the presence of the core (C1) by methods known from the literature, in particular via emulsion polymerization (Encyclopedia of Polymer Science and Engineering, vol. 1, pp. 401 et seq.). The “seed method” used here prevents formation of any new particles during preparation of the two graft shells. The seed method moreover permits the number and the nature of the particles in both graft stages to be determined via the amount and the nature of the emulsifier used. The emulsion polymerization is usually initiated via polymerization initiators.

Ionic and non-ionic emulsifiers may be used in the emulsion polymerization process.

Examples of suitable emulsifiers are dioctyl sodium sulfosuccinate, sodium lauryl sulfate, sodium dodecyl benzenesulfonate, alkylphenoxypolyethylenesulfonates and salts of long-chain carboxylic and long-chain sulfonic acids.

Examples of non-ionogenic emulsifiers are fatty alcohol polyglycol ethers, alkylaryl polyglycol ethers, fatty acid monoethanolamides, ethoxylated fatty amides and the corresponding amines.

The total amount of emulsifier, based on the total weight of the emulsion graft copolymer, is preferably from 0.05 to 5% by weight.

Polymerization initiators which may be used comprise ammonium and alkali metal peroxodisulfates, such as potassium peroxodisulfate, and combined initiator systems, such as sodium persulfate, sodium hydrosulfite, potassium persulfate, sodium formaldehydesulfoxylate and potassium peroxodisulfate, sodium dithionite-iron(II) sulfate; in the case of the ammonium and alkali metal peroxodisulfates, which must be activated by heat, the polymerization temperature may be from 50 to 100° C., and in the case of the combined initiators which act as redox systems, it may be lower than this, for example in the range from 20 to 50° C.

The total amount of initiator is preferably between 0.02 and 1.0% by weight, based on the finished emulsion polymer.

It is also possible to use polymerization regulators, both in preparing the base, i.e. the core (C1), and also in preparing the two graft stages, i.e. the two graft shells (C2) and (C3). Examples of polymerization regulators are alkyl mercaptans, such as n-dodecyl or tert-dodecyl mercaptan. The usual amount used of the polymerization regulators is from 0.01 to 1.0% by weight, based on the respective stage.

In other respects, the emulsion graft copolymer to be used according to the invention is prepared by taking an aqueous mixture consisting of monomers, crosslinker, emulsifier, initiator, regulator and a buffer system in a reactor in which inert conditions have been established using nitrogen, stirring the mixture cold to create inert conditions and then bringing it to the polymerization temperature over the course of from 15 to 120 minutes. It is then polymerized to a conversion of at least 95%. Monomers, crosslinking agent, emulsifier, initiator and regulator may also be introduced entirely or to some extent in the form of a feed to the initial aqueous charge.

After the reaction has continued for from 15 to 120 minutes, if desired, the stage (C2) and (C3) are produced with feed of the monomers in the presence of the previously formed stage (C1), via emulsion polymerization.

The emulsion graft copolymer is isolated from the resultant latex in a known manner by precipitation, filtration and then drying. For the precipitation, it is possible to use, for example, aqueous solutions of inorganic salts, such as sodium chloride, sodium sulfate, magnesium sulfate and calcium chloride, aqueous solutions of salts of formic acid, such as magnesium formate, calcium formate and zinc formate, aqueous solutions of inorganic acids, such as sulfuric and phosphoric acid, aqueous solutions of ammonia and amines, and other alkaline aqueous solutions, e.g. of sodium hydroxide and potassium hydroxide. However, physical methods may also be used for the precipitation process, examples being freeze-precipitation, shear-precipitation, steam-precipitation.

The drying can, for example, be carried out by freeze-drying, spray-drying, fluidized-bed drying and air-circulation drying.

The precipitated emulsion graft copolymer may also be further processed without drying.

The swelling index Si of the graft copolymer (C) is preferably from 10 to 40, in particular from 12 to 35. This swelling index is determined via measurement of swelling in toluene at room temperature.

In one preferred embodiment, a feature of the inventive thermoplastic molding compositions is that the refractive index (n_{D}−C₂) of the first graft shell (C2) is greater than the refractive index (n_{D}−C₃) of the second graft shell (C3). The refractive index (n_{D}−C₂) of the first graft shell (C2) is preferably greater by at least 2%, in particular by at least 3%, than the refractive index (n_{D}−C₃) of the second graft shell (C3).

In another preferred embodiment, a feature of the inventive thermoplastic molding compositions is that the refractive index (n_{D}−C₂C₃) of the entire graft shell is smaller than the refractive index (n_{D}−C1) of the core (C1). The refractive index (n_{D}−C₂C₃) of the entire graft shell is preferably smaller by at least 0.1%, in particular by at least 1.0%, than the refractive index (n_{D}−C1) of the core (C1).

In another preferred embodiment, a feature of the inventive thermoplastic molding compositions is that the extent of the difference between the refractive index (n_{D}−C) of the entire component (C) and the refractive index (n_{D}−AB) of the entire matrix of components (A) and (B) is smaller than or equal to 0.02, in particular smaller than or equal to 0.015.

In another preferred embodiment, a feature of the inventive molding compositions is that the extent of the difference between the refractive index (n_{D}−C₂C₃) of the entire graft shell of the graft copolymer C and the refractive index (n_{D}−C1) of the core (C1) is smaller than 0.06. The molding compositions of this embodiment feature particularly little yellow tinge at the edges.

Each of the refractive indices n_{D} [dimensionless] mentioned is to be determined by the methods mentioned below:

Refractive indices (n_{D}−C1), (n_{D}−C), and (n_{D}−AB) are measured on foils produced in an IWK press by first pressing at 200° C. at a pressure of from 3 to 5 bar for 2 min and finally further pressing at 200° C. and 200 bar for 3 min, starting from the respective polymer cores (C1), polymers (C), or polymer mixtures composed of components (A) and (B). The measurements are made at 20° C., using an Abbé refractometer and the method for measuring refractive indices of solids (see Ullmanns Encyklopädie der technischen Chemie [Ullmann's Encyclopedia of Industrial Chemistry], volume 2/1, p. 486, edited by E. Foerst; Urban & Schwarzenberg, Munich, Berlin 1961).

The refractive index (n_{D}−C₂) is to be calculated incrementally from the following formula:

$$( {n}_{D} - {C}_{2} ) = {\sum }_{i = 1}^{n} [ {x}_{i}^{C 2} * ( nD - {M}_{i}^{C 2} ) ] / {\sum }_{i = 1}^{n} [ {x}_{i}^{C 2} ]$$

where xᵢ^{C2} are the parts by weight of the monomer components Mᵢ^{C2} of which the graft shell (C2) is composed, (n_{D}−Mᵢ^{C2}) is the refractive index increment of the monomer component Mᵢ^{C2} of which the graft shell (C2) is composed, and n is the number of different monomer components of which the graft shell (C2) is composed.

The refractive index (n_{D}−C₃) is to be calculated incrementally from the following formula:

$$( {n}_{D} - {C}_{3} ) = {\sum }_{i = 1}^{n} [ {x}_{i}^{C 3} * ( nD - {M}_{i}^{C 3} ) ] / {\sum }_{i = 1}^{n} [ {x}_{i}^{C 3} ]$$

where xᵢ^{C3} are the parts by weight of the monomer components Mᵢ^{C3} of which the graft shell (C3) is composed, (n_{D}−Mᵢ^{C3}) is the refractive index increment of the monomer component Mᵢ^{C3} of which the graft shell (C3) is composed, and n is the number of different monomer components of which the graft shell (C3) is composed.

The following values are used as refractive index increments (n_{D}−Mᵢ^{C2}) and, respectively, (n_{D}−Mᵢ^{C3}) of the monomer components Mᵢ^{C2} and, respectively, Mᵢ^{C3} of which the graft shells (C2) and, respectively, (C3) are composed:

| | |
|---|---|
| Styrene: | 1.594 |
| Methyl methacrylate: | 1.495 |
| Butyl acrylate: | 1.419 |
| Dihydrodicyclopentadienyl acrylate: | 1.497 |
| Butanediol diacrylate: | 1.419 |
| Butylene glycol dimethacrylate: | 1.419 |

The refractive index (n_{D}−C₂C₃) of the entire graft shell was calculated from the following formula:
(n_{D}−C₂C₃)=[y^{C2}*(n_{D}−C₂)+y^{C3}*(n_{D}−C₃)]/[y^{C2}+y^{C3}]
where y^{C2} and, respectively, y^{C3} are the respective parts by weight of the first graft shell (C2) and, respectively, second graft shell (C3) of which the entire graft shell is composed, and the refractive indices (n_{D}−C₂) and (n_{D}−C₃) are determined as described above.
Component (D)

Component (D) is a highly branched or hyperbranched polymer, selected from
(D1) highly branched or hyperbranched polycarbonates, and
(D2) highly branched or hyperbranched polyesters of Aₓ+B_{y} type, where x is at least 1.1, and y is at least 2.1.

Use may be made of either polycarbonates (D1) or polyesters (D2), or of both components (D1) and (D2). If use is made of mixtures of (D1) and (D2), the mixing ratio (D1):(D2) is generally from 1:20 to 20:1, preferably from 1:15 to 15:1, in particular from 1:5 to 5:1, based on weight.

For the purposes of the invention, the feature “highly branched or hyperbranched” in the context of polymers or of polycarbonates or polyesters of (D), (D1), and, respectively, (D2) means that the degree of branching DB of the substances concerned, defined as

$$DB = \frac{T + Z}{T + Z + L} \times 100 \% ,$$

(where T is the average number of terminal monomer units, Z is the average number of branched monomer units, and L is the average number of linear monomer units in the macromolecules of the respective substances)
is from 10 to 99.9%, preferably from 20 to 99%, particularly preferably from 20 to 95%.
Component (D1)

For the purposes of this invention, highly branched or hyperbranched polycarbonates (D1) are non-crosslinked macromolecules having hydroxy groups and carbonate groups, these having both structural and molecular non-uniformity. Their structure may firstly be based on a central molecule in the same way as dendrimers, but with non-uniform chain length of the branches. Secondly, they may also have a linear structure with functional pendant groups, or else they may combine the two extremes, having linear and branched molecular portions. See also P. J. Flory, J. Am. Chem. Soc. 1952, 74, 2718, and H. Frey et al., Chem. Eur. J. 2000, 6, No. 14, 2499 for the definition of dendrimeric and hyperbranched polymers.

“Highly branched or hyperbranched” in the context of the present invention means that the degree of branching (DB), i.e. the average number of dendritic linkages plus the average number of end groups per molecule, is from 10 to 99.9%, preferably from 20 to 99%, particularly preferably from 20 to 95%.

“Dendrimeric” in the context of the present invention means that the degree of branching is from 99.9 to 100%. See H. Frey et al., Acta Polym. 1997, 48, 30 for the definition of “degree of branching”.

Component D1) preferably has a number-average molar mass Mₙ of from 100 to 15 000 g/mol, preferably from 200 to 12 000 g/mol, and in particular from 500 to 10 000 g/mol (GPC, PMMA standard, dimethylacetamide eluant).

The glass transition temperature Tg is in particular from −80 to 140° C., preferably from −60 to 120° C. (according to DSC, DIN 53765).

In particular, the viscosity (mPas) at 23° C. (to DIN 53019) is from 50 to 200 000, in particular from 100 to 150 000, and very particularly preferably from 200 to 100 000.

Component D1) is preferably obtainable via a process which comprises at least the following steps:
a) reaction of at least one organic carbonate (I) of the general formula RO(CO)OR with at least one aliphatic alcohol (II) which has at least three OH groups, with elimination of alcohols ROH, to give one or more condensates (K), where each R, independently of the others, is a straight-chain or branched aliphatic, araliphatic or aromatic hydrocarbon radical having from 1 to 20 carbon atoms, and
b) intermolecular reaction of the condensates (K) to give a highly branched or hyperbranched polycarbonate of high functionality,
   where the quantitative proportion of the OH groups to the carbonates in the reaction mixture is selected in such a way that the condensates (K) have an average of either one carbonate group and more than one OH group or one OH group and more than one carbonate group.

Each of the radicals R of the organic carbonates (I) used as starting material and having the general formula RO(CO)OR is, independently of the others, a straight-chain or branched aliphatic, araliphatic, or aromatic hydrocarbon radical having from 1 to 20 carbon atoms. The two radicals R may also have bonding to one another to form a ring. The radical is preferably an aliphatic hydrocarbon radical, and particularly preferably a straight-chain or branched alkyl radical having from 1 to 5 carbon atoms.

By way of example, dialkyl or diaryl carbonates may be prepared from the reaction of aliphatic, araliphatic, or aromatic alcohols, preferably monoalcohols, with phosgene. They may also be prepared by way of oxidative carbonylation of the alcohols or phenols by means of CO in the presence of noble metals, oxygen, or NOₓ. In relation to preparation methods for diaryl or dialkyl carbonates, see also “Ullmann's Encyclopedia of Industrial Chemistry”, 6th edition, 2000 Electronic Release, Verlag Wiley-VCH.

Examples of suitable carbonates comprise aliphatic or aromatic carbonates, such as ethylene carbonate, propylene 1,2- or 1,3-carbonate, diphenyl carbonate, ditolyl carbonate, dixylyl carbonate, dinaphthyl carbonate, ethyl phenyl carbonate, dibenzyl carbonate, dimethyl carbonate, diethyl carbonate, dipropyl carbonate, dibutyl carbonate, diisobutyl carbonate, dipentyl carbonate, dihexyl carbonate, dicyclohexyl carbonate, diheptyl carbonate, dioctyl carbonate, didecyl carbonate, or didodecyl carbonate.

It is preferable to use aliphatic carbonates, in particular those in which the radicals comprise from 1 to 5 carbon atoms, e.g. dimethyl carbonate, diethyl carbonate, dipropyl carbonate, dibutyl carbonate, or diisobutyl carbonate.

The organic carbonates are reacted with at least one aliphatic alcohol (II) which has at least 3 OH groups, or with mixtures of two or more different alcohols.

Examples of compounds having at least three OH groups comprise glycerol, trimethylolmethane, trimethylolethane, trimethylolpropane, 1,2,4-butanetriol, tris(hydroxymethyl)amine, tris(hydroxyethyl)amine, tris(hydroxypropyl)amine, pentaerythritol, bis(trimethylolpropane), tetrahydroxyethyl isocyanurate or sugars, e.g. glucose, trifunctional or higher-functionality polyetherols based on trifunctional or higher-functionality alcohols and ethylene oxide, propylene oxide, or butylene oxide, or polyesterols. Particular preference is given here to glycerol, trimethylolethane, trimethylolpropane, 1,2,4-butanetriol, pentaerythritol, and also their polyetherols based on ethylene oxide or propylene oxide.

These polyhydric alcohols may also be used in a mixture with dihydric alcohols (II′), with the proviso that the average OH functionality of all of the alcohols used together is greater than 2. Examples of suitable compounds having two OH groups comprise ethylene glycol, diethylene glycol, triethylene glycol, 1,2- and 1,3-propanediol, dipropylene glycol, tripropylene glycol, neopentyl glycol, 1,2-, 1,3-, and 1,4-butanediol, 1,2-, 1,3-, and 1,5-pentanediol, hexanediol, cyclopentanediol, cyclohexanediol, cyclohexanedimethanol, and dihydric polyether- or polyesterols.

The reaction of the carbonate with the alcohol or alcohol mixture to give the inventive highly branched polycarbonate with high functionality generally takes place with elimination of the monofunctional alcohol or phenol from the carbonate molecule.

After the reaction, i.e. without further modification, the high-functionality highly branched polycarbonates formed by the inventive process have termination by hydroxy groups and/or by carbonate groups. They have good solubility in various solvents, e.g. in water, alcohols, such as methanol, ethanol, butanol, alcohol/water mixtures, acetone, 2-butanone, ethyl acetate, butyl acetate, methoxypropyl acetate, methoxyethyl acetate, tetrahydrofuran, dimethylformamide, dimethylacetamide, N-methylpyrrolidone, ethylene carbonate, or propylene carbonate.

For the purposes of this invention, a high-functionality polycarbonate is a product which, besides the carbonate groups which form the polymer skeleton, further has at least three, preferably at least six, more preferably at least ten, terminal or pendant functional groups. The functional groups are carbonate groups and/or OH groups. There is in principle no upper restriction on the number of the terminal or pendant functional groups, but products having a very high number of functional groups can have undesired properties, such as high viscosity or poor solubility. The high-functionality polycarbonates of the present invention mostly have not more than 500 terminal or pendant functional groups, preferably not more than 100 terminal or pendant functional groups.

When preparing the high-functionality polycarbonates (D1), it is necessary to adjust the ratio of the compounds comprising OH groups to the carbonate in such a way that the simplest resultant condensate (hereinafter termed condensate (K)) has an average of either one carbonate group and more than one OH group or one OH group and more than one carbonate group. The simplest structure of the condensate (K) composed of a carbonate (I) and a di- or polyalcohol (II) here results in the arrangement XYₙ or YₙX, where X is a carbonate group, Y is a hydroxy group, and n is generally a number from 1 to 6, preferably from 1 to 4, particularly preferably from 1 to 3. The reactive group which is the single resultant group here is generally termed “focal group” below.

By way of example, if during the preparation of the simplest condensate (K) from a carbonate and a dihydric alcohol the reaction ratio is 1:1, the average result is a molecule of XY type, illustrated by the general formula 1.

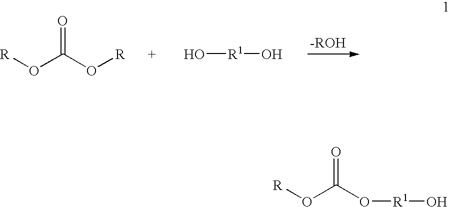

During the preparation of the condensate (K) from a carbonate and a trihydric alcohol with a reaction ratio of 1:1, the average result is a molecule of XY₂ type, illustrated by the general formula 2. A carbonate group is focal group here.

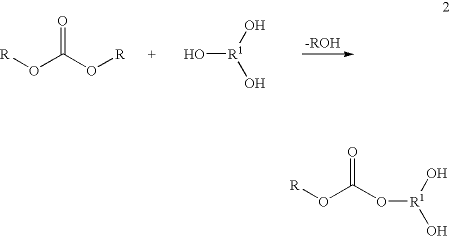

During the preparation of the condensate (K) from a carbonate and a tetrahydric alcohol, likewise with the reaction ratio 1:1, the average result is a molecule of XY₃ type, illustrated by the general formula 3. A carbonate group is focal group here.

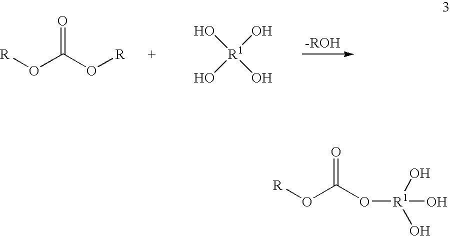

R in the formulae 1-3 has the definition given at the outset, and R¹ is an aliphatic radical.

The condensate (K) may, by way of example, also be prepared from a carbonate and a trihydric alcohol, as illustrated by the general formula 4, the molar reaction ratio being 2:1. Here, the average result is a molecule of X₂Y type, an OH group being focal group here. In formula 4, R and R¹ are as defined in formulae 1-3.

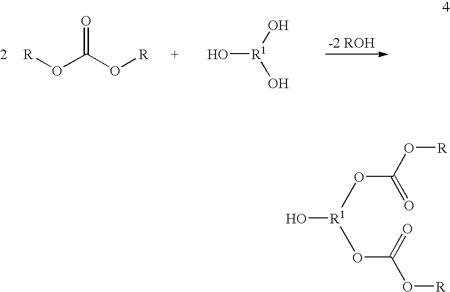

If difunctional compounds, e.g. a dicarbonate or a diol, are also added to the components, this extends the chains, as illustrated by way of example in the general formula 5. The average result is again a molecule of XY₂ type, a carbonate group being focal group.

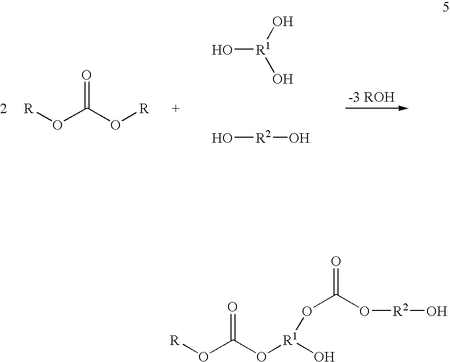

In formula 5, R² is an organic, preferably aliphatic radical, and R and R¹ are as defined above.

According to the invention, the simple condensates (K) described by way of example in the formulae 1-5 preferentially react intermolecularly to form high-functionality polycondensates, hereinafter termed polycondensates (P). The reaction to give the condensate (K) and to give the polycondensate (P) usually takes place at a temperature of from 0 to 250° C., preferably from 60 to 160° C., in bulk or in solution. Use may generally be made here of any of the solvents which are inert with respect to the respective starting materials. Preference is given to use of organic solvents, e.g. decane, dodecane, benzene, toluene, chlorobenzene, xylene, dimethylformamide, dimethylacetamide, or solvent naphtha.

In one preferred embodiment, the condensation reaction is carried out in bulk. The phenol or the monohydric alcohol ROH liberated during the reaction can be removed by distillation from the reaction equilibrium to accelerate the reaction, if appropriate at reduced pressure.

If removal by distillation is intended, it is generally advisable to use those carbonates which liberate alcohols ROH with a boiling point below 140° C. during the reaction.

Catalysts or catalyst mixtures may also be added to accelerate the reaction. Suitable catalysts are compounds which catalyze esterification or transesterification reactions, e.g. alkali metal hydroxides, alkali metal carbonates, alkali metal hydrogencarbonates, preferably of sodium, or potassium, or of cesium, tertiary amines, guanidines, ammonium compounds, phosphonium compounds, organoaluminum, organotin, organozinc, organotitanium, organozirconium, or organobismuth compounds, or else what are known as double metal cyamide (DMC) catalysts, e.g. as described in DE 10138216 or DE 10147712.

It is preferable to use potassium hydroxide, potassium carbonate, potassium hydrogencarbonate, diazabicyclooctane (DABCO), diazabicyclononene (DBN), diazabicycloundecene (DBU), imidazoles, such as imidazole, 1-methylimidazole, or 1,2-dimethylimidazole, titanium tetrabutoxide, titanium tetraisopropoxide, dibutyltin oxide, dibutyltin dilaurate, stannous dioctoate, zirconium acetylacetonate, or mixtures thereof.

The amount of catalyst generally added is from 50 to 10 000 ppm by weight, preferably from 100 to 5000 ppm by weight, based on the amount of the alcohol mixture or alcohol used.

It is also possible to control the intermolecular polycondensation reaction via addition of the suitable catalyst or else via selection of a suitable temperature. The average molecular weight of the polymer (P) may moreover be adjusted by way of the composition of the starting components and by way of the residence time.

The condensates (K) and the polycondensates (P) prepared at an elevated temperature are usually stable at room temperature for a relatively long period.

The nature of the condensates (K) permits polycondensates (P) with different structures to result from the condensation reaction, these having branching but no crosslinking. Furthermore, in the ideal case, the polycondensates (P) have either one carbonate group as focal group and more than two OH groups or else one OH group as focal group and more than two carbonate groups. The number of the reactive groups here is the result of the nature of the condensates (K) used and the degree of polycondensation.

By way of example, a condensate (K) according to the general formula 2 can react via triple intermolecular condensation to give two different polycondensates (P), represented in the general formulae 6 and 7.

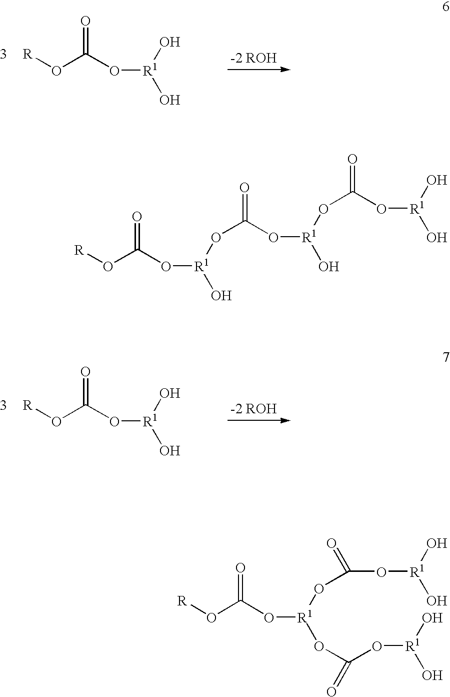

In formulae 6 and 7, R and R¹ are as defined above.

There are various ways of terminating the intermolecular polycondensation reaction. By way of example, the temperature may be lowered to a range where the reaction stops and the product (K) or the polycondensate (P) is storage-stable.

In another embodiment, as soon as the intermolecular reaction of the condensate (K) has produced a polycondensate (P) with the desired degree of polycondensation, a product having groups reactive toward the focal group of (P) may be added to the product (P) to terminate the reaction. For example, in the case of a carbonate group as focal group, by way of example, a mono-, di-, or polyamine may be added. In the case of a hydroxy group as focal group, by way of example, a mono-, di-, or polyisocyanate, or a compound comprising epoxy groups, or an acid derivative which reacts with OH groups, can be added to the product (P).

The inventive high-functionality polycarbonates are mostly prepared in the pressure range from 0.1 mbar to 20 bar, preferably at from 1 mbar to 5 bar, in reactors or reactor cascades which are operated batchwise, semicontinuously, or continuously.

The inventive products can be further processed without further purification after their preparation by virtue of the abovementioned adjustment of the reaction conditions and, if appropriate, by virtue of the selection of the suitable solvent.

In another preferred embodiment, the inventive polycarbonates may comprise other functional groups besides the functional groups present at this stage by virtue of the reaction. The functionalization may take place during the process to increase molecular weight, or else subsequently, i.e. after completion of the actual polycondensation.

If, prior to or during the process to increase molecular weight, components are added which have other functional groups or functional elements besides hydroxy or carbonate groups, the result is a polycarbonate polymer with randomly distributed functionalities other than the carbonate or hydroxy groups.

Effects of this type can, by way of example, be achieved via addition, during the polycondensation, of compounds which bear other functional groups or functional elements, such as mercapto groups, primary, secondary or tertiary amino groups, ether groups, derivatives of carboxylic acids, derivatives of sulfonic acids, derivatives of phosphonic acids, silane groups, siloxane groups, aryl radicals, or long-chain alkyl radicals, besides hydroxy groups or carbonate groups. Examples of compounds which may be used for modification by means of carbamate groups are ethanolamine, propanolamine, isopropanolamine, 2-(butylamino)ethanol, 2-(cyclohexylamino)ethanol, 2-amino-1-butanol, 2-(2′-aminoethoxy)ethanol or higher alkoxylation products of ammonia, 4-hydroxypiperidine, 1-hydroxyethylpiperazine, diethanolamine, dipropanolamine, diisopropanolamine, tris(hydroxymethyl)aminomethane, tris(hydroxyethyl)aminomethane, ethylenediamine, propylenediamine, hexamethylenediamine or isophoronediamine.

An example of a compound which can be used for modification with mercapto groups is mercaptoethanol. By way of example, tertiary amino groups can be produced via incorporation of N-methyldiethanolamine, N-methyldipropanolamine or N,N-dimethyl-ethanolamine. By way of example, ether groups may be generated via co-condensation of dihydric or higher polyhydric polyetherols. Long-chain alkyl radicals can be introduced via reaction with long-chain alkanediols, and reaction with alkyl or aryl diisocyanates generates polycarbonates having alkyl, aryl, and urethane groups.

Subsequent functionalization can be achieved by using an additional step of the process (step c)) to react the resultant high-functionality highly branched, or high-functionality hyperbranched, polycarbonate with a suitable functionalizing reagent which can react with the OH and/or carbonate groups of the polycarbonate.

By way of example, high-functionality highly branched, or high-functionality hyperbranched, polycarbonates comprising hydroxy groups can be modified via addition of molecules comprising acid groups or comprising isocyanate groups. By way of example, polycarbonates comprising acid groups can be obtained via reaction with compounds comprising anhydride groups.

High-functionality polycarbonates comprising hydroxy groups may moreover also be converted into high-functionality polycarbonate polyether polyols via reaction with alkylene oxides, e.g. ethylene oxide, propylene oxide, or butylene oxide.

A great advantage of the process for preparation of (D1) is its cost-effectiveness. Both the reaction to give a condensate (K) or polycondensate (P) and also the reaction of (K) or (P) to give polycarbonates with other functional groups or elements can take place in one reactor, this being advantageous technically and in terms of cost-effectiveness.

Component (D2)

The inventive polymer blends comprise, as component (D2), at least one highly branched or hyperbranched polyester of Aₓ+B_{y} type, where

| | |
|---|---|
| x | is at least 1.1, preferably at least 1.3, in particular at least 2 |
| y | is at least 2.1, preferably at least 2.5, in particular at least 3. |

The units A or B used may, of course, also comprise mixtures, where x and y are then the average numerical value, i.e. the average functionality in the mixture.

An Aₓ+B_{y}-type polyester is a condensate composed of an x-functional molecule A and a y-functional molecule B. By way of example, mention may be made of a polyester composed of adipic acid as molecule A (x=2) and glycerol as molecule B (y=3).

For the purposes of this invention, highly branched or hyperbranched polyesters (D2) are non-crosslinked macromolecules having hydroxy groups and carboxy groups, these having both structural and molecular non-uniformity. Their structure may firstly be based on a central molecule in the same way as dendrimers, but with non-uniform chain length of the branches. Secondly, they may also have a linear structure with functional pendant groups, or else they may combine the two extremes, having linear and branched molecular portions. See also P. J. Flory, J. Am. Chem. Soc. 1952, 74, 2718, and H. Frey et al., Chem. Eur. J. 2000, 6, No. 14, 2499 for the definition of dendrimeric and hyperbranched polymers.

“Highly branched or hyperbranched” in the context of the present invention means that the degree of branching (DB), i.e. the average number of dendritic linkages plus the average number of end groups per molecule, is from 10 to 99.9%, preferably from 20 to 99%, particularly preferably from 20 to 95%.

“Dendrimeric” in the context of the present invention means that the degree of branching is from 99.9 to 100%. See H. Frey et al., Acta Polym. 1997, 48, 30 for the definition of “degree of branching”.

Component (D2) preferably has an Mₙ of from 300 to 30 000 g/mol, in particular from 400 to 25 000 g/mol, and very particularly from 500 to 20 000 g/mol, determined by means of GPC, PMMA standard, dimethylacetamide eluent.

(D2) preferably has an OH number of from 0 to 600 mg KOH/g of polyester, preferably of from 1 to 500 mg KOH/g of polyester, in particular from 20 to 500 mg KOH/g of polyester to DIN 53240, and preferably a COOH number of from 0 to 600 mg KOH/g of polyester, preferably from 1 to 500 mg KOH/g of polyester, and in particular from 2 to 500 mg KOH/g of polyester.

The T_{g} is preferably from −50° C. to 140° C., and in particular from −50 to 100° C. (by means of DSC, to DIN 53765).

Preference is particularly given to those components (D2) in which at least one OH or COOH number is greater than 0, preferably greater than 0.1, and in particular greater than 0.5.

The inventive component (D2) is in particular obtainable via the processes described below, inter alia by reacting
(a) one or more dicarboxylic acids or one or more derivatives of the same with one or more trihydric alcohols
   or
(b) one or more tricarboxylic acids or higher polycarboxylic acids or one or more derivatives of the same with one or more diols
   in the presence of a solvent and optionally in the presence of an inorganic, organometallic, or low-molecular-weight organic catalyst, or of an enzyme. The reaction in solvent is the preferred preparation method.

For the purposes of the present invention, high-functionality hyperbranched polyesters (D2) have molecular and structural non-uniformity. Their molecular non-uniformity distinguishes them from dendrimers, and they can therefore be prepared at considerably lower cost.

Among the dicarboxylic acids which can be reacted according to variant (a) are, by way of example, oxalic acid, malonic acid, succinic acid, glutaric acid, adipic acid, pimelic acid, suberic acid, azelaic acid, sebacic acid, undecane-α,ω-dicarboxylic acid, dodecane-α,ω-dicarboxylic acid, cis- and trans-cyclohexane-1,2-dicarboxylic acid, cis- and trans-cyclohexane-1,3-dicarboxylic acid, cis- and trans-cyclohexane-1,4-dicarboxylic acid, cis- and trans-cyclopentane-1,2-dicarboxylic acid, and cis- and trans-cyclopentane-1,3-dicarboxylic acid,

and the abovementioned dicarboxylic acids may have substitution by one or more radicals selected from

C₁-C₁₀-alkyl groups, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, isoheptyl, n-octyl, 2-ethylhexyl, n-nonyl, and n-decyl,

C₃-C₁₂-cycloalkyl groups, such as cyclopropyl, cyclobutyl, cyclopentyl, cyclohexyl, cycloheptyl, cyclooctyl, cyclononyl, cyclodecyl, cycloundecyl, and cyclododecyl; preference is given to cyclopentyl, cyclohexyl, and cycloheptyl;

alkylene groups, such as methylene or ethylidene, or

C₆-C₁₄-aryl groups, such as phenyl, 1-naphthyl, 2-naphthyl, 1-anthryl, 2-anthryl, 9-anthryl, 1-phenanthryl, 2-phenanthryl, 3-phenanthryl, 4-phenanthryl, and 9-phenanthryl, preferably phenyl, 1-naphthyl, and 2-naphthyl, particularly preferably phenyl.

Examples which may be mentioned of representatives of substituted dicarboxylic acids are: 2-methylmalonic acid, 2-ethylmalonic acid, 2-phenylmalonic acid, 2-methylsuccinic acid, 2-ethylsuccinic acid, 2-phenylsuccinic acid, itaconic acid, 3,3-dimethylglutaric acid.

Among the dicarboxylic acids which can be reacted according to variant (a) are also ethylenically unsaturated acids, such as maleic acid and fumaric acid, and aromatic dicarboxylic acids, such as phthalic acid, isophthalic acid or terephthalic acid.

It is also possible to use mixtures of two or more of the abovementioned representative compounds.

The dicarboxylic acids may either be used as they stand or be used in the form of derivatives.

Derivatives are preferably
the relevant anhydrides in monomeric or else polymeric form,
mono- or dialkyl esters, preferably mono- or dimethyl esters, or the corresponding mono- or diethyl esters, or else the mono- and dialkyl esters derived from higher alcohols, such as n-propanol, isopropanol, n-butanol, isobutanol, tert-butanol, n-pentanol, n-hexanol,
and also mono- and divinyl esters, and
mixed esters, preferably methyl ethyl esters.

In the preferred preparation process it is also possible to use a mixture composed of a dicarboxylic acid and one or more of its derivatives. Equally, it is possible to use a mixture of two or more different derivatives of one or more dicarboxylic acids.

It is particularly preferable to use succinic acid, glutaric acid, adipic acid, phthalic acid, isophthalic acid, terephthalic acid, or the mono- or dimethyl ester thereof. It is very particularly preferable to use adipic acid.

Examples of at least trihydric alcohols which may be reacted are: glycerol, butane-1,2,4-triol, n-pentane-1,2,5-triol, n-pentane-1,3,5-triol, n-hexane-1,2,6-triol, n-hexane-1,2,5-triol, n-hexane-1,3,6-triol, trimethylolbutane, trimethylolpropane or ditrimethylolpropane, trimethylolethane, pentaerythritol or dipentaerythritol; sugar alcohols, such as mesoerythritol, threitol, sorbitol, mannitol, or mixtures of the above at least trihydric alcohols. It is preferable to use glycerol, trimethylolpropane, trimethylolethane, and pentaerythritol.

Examples of tricarboxylic acids or polycarboxylic acids which can be reacted according to variant (b) are benzene-1,2,4-tricarboxylic acid, benzene-1,3,5-tricarboxylic acid, benzene-1,2,4,5-tetracarboxylic acid, and mellitic acid.

Tricarboxylic acids or polycarboxylic acids may be used in the inventive reaction either as they stand or else in the form of derivatives.

Derivatives are preferably
the relevant anhydrides in monomeric or else polymeric form,
mono-, di-, or trialkyl esters, preferably mono-, di-, or trimethyl esters, or the corresponding mono-, di-, or triethyl esters, or else the mono-, di-, and triesters derived from higher alcohols, such as n-propanol, isopropanol, n-butanol, isobutanol, tert-butanol, n-pentanol, n-hexanol, or else mono-, di-, or trivinyl esters
and mixed methyl ethyl esters.

For the purposes of the present invention, it is also possible to use a mixture composed of a tri- or polycarboxylic acid and one or more of its derivatives. For the purposes of the present invention it is likewise possible to use a mixture of two or more different derivatives of one or more tri- or polycarboxylic acids, in order to obtain component (D2).

Examples of diols used for variant (b) are ethylene glycol, propane-1,2-diol, propane-1,3-diol, butane-1,2-diol, butane-1,3-diol, butane-1,4-diol, butane-2,3-diol, pentane-1,2-diol, pentane-1,3-diol, pentane-1,4-diol, pentane-1,5-diol, pentane-2,3-diol, pentane-2,4-diol, hexane-1,2-diol, hexane-1,3-diol, hexane-1,4-diol, hexane-1,5-diol, hexane-1,6-diol, hexane-2,5-diol, heptane-1,2-diol, 1,7-heptanediol, 1,8-octanediol, 1,2-octanediol, 1,9-nonanediol, 1,10-decanediol, 1,2-decanediol, 1,12-dodecanediol, 1,2-dodecanediol, 1,5-hexadiene-3,4-diol, cyclopentanediols, cyclohexanediols, inositol and derivatives, (2)-methylpentane-2,4-diol, 2,4-dimethylpentane-2,4-diol, 2-ethylhexane-1,3-diol, 2,5-dimethylhexane-2,5-diol, 2,2,4-trimethylpentane-1,3-diol, pinacol, diethylene glycol, triethylene glycol, dipropylene glycol, tripropylene glycol, polyethylene glycols HO(CH₂CH₂O)ₙ—H or polypropylene glycols HO(CH[CH₃]CH₂O)ₙ—H or mixtures of two or more representative compounds of the above compounds, where n is a whole number and n=4. One, or else both, hydroxy groups here in the abovementioned diols may also be substituted by SH groups. Preference is given to ethylene glycol, propane-1,2-diol, and diethylene glycol, triethylene glycol, dipropylene glycol, and tripropylene glycol.

The molar ratio of the molecules A to molecules B in the Aₓ+B_{y} polyester in the variants (a) and (b) is from 4:1 to 1:4, in particular from 2:1 to 1:2.

The at least trihydric alcohols reacted according to variant (a) of the process may have hydroxy groups of which all have identical reactivity. Preference is also given here to at least trihydric alcohols whose OH groups initially have identical reactivity, but where reaction with at least one acid group can induce a fall-off in reactivity of the remaining OH groups as a result of steric or electronic effects. By way of example, this applies when trimethylolpropane or pentaerythritol is used.

However, the at least trihydric alcohols reacted according to variant (a) may also have hydroxy groups having at least two different chemical reactivities.

The different reactivity of the functional groups here may either derive from chemical causes (e.g. primary/secondary/tertiary OH group) or from steric causes.

By way of example, the triol may comprise a triol which has primary and secondary hydroxy groups, preferred example being glycerol.

When the inventive reaction is carried out according to variant (a), it is preferable to operate in the absence of diols and monohydric alcohols.

When the inventive reaction is carried out according to variant (b), it is preferable to operate in the absence of mono- or dicarboxylic acids.

The process is carried out in the presence of a solvent. Examples of suitable compounds are hydrocarbons, such as paraffins or aromatics. Particularly suitable paraffins are n-heptane and cyclohexane. Particularly suitable aromatics are toluene, ortho-xylene, meta-xylene, para-xylene, xylene in the form of an isomer mixture, ethylbenzene, chlorobenzene and ortho- and meta-dichlorobenzene. Other very particularly suitable solvents in the absence of acidic catalysts are: ethers, such as dioxane or tetrahydrofuran, and ketones, such as methyl ethyl ketone and methyl isobutyl ketone.

According to the invention, the amount of solvent added is at least 0.1% by weight, based on the weight of the starting materials used and to be reacted, preferably at least 1% by weight, and particularly preferably at least 10% by weight. It is also possible to use excesses of solvent, based on the weight of starting materials used and to be reacted, e.g. from 1.01 to 10 times the amount. Solvent amounts of more than 100 times the weight of the starting materials used and to be reacted are not advantageous, because the reaction rate reduces markedly at markedly lower concentrations of the reactants, giving uneconomically long reaction times.

To carry out the process preferred according to the invention, operations may be carried out in the presence of a dehydrating agent as additive, added at the start of the reaction. Suitable examples are molecular sieves, in particular 4 Å molecular sieve, MgSO₄, and Na₂SO₄. During the reaction it is also possible to add further dehydrating agent or to replace dehydrating agent by fresh dehydrating agent. During the reaction it is also possible to remove the water or alcohol formed by distillation and, for example, to use a water separator.

The process may be carried out in the absence of acidic catalysts. It is preferable to operate in the presence of an acidic inorganic, organometallic, or organic catalyst, or a mixture composed of two or more acidic inorganic, organometallic, or organic catalysts.

For the purposes of the present invention, examples of acidic inorganic catalysts are sulfuric acid, phosphoric acid, phosphonic acid, hypophosphorous acid, aluminum sulfate hydrate, alum, acidic silica gel (pH=6, in particular =5), and acidic aluminum oxide. Examples of other compounds which can be used as acidic inorganic catalysts are aluminum compounds of the general formula Al(OR)₃ and titanates of the general formula Ti(OR)₄, where each of the radicals R may be identical or different and is selected independently of the others from

C₁-C₁₀-alkyl radicals, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, isoheptyl, n-octyl, 2-ethylhexyl, n-nonyl, and n-decyl,

C₃-C₁₂-cycloalkyl radicals, such as cyclopropyl, cyclobutyl, cyclopentyl, cyclohexyl, cycloheptyl, cyclooctyl, cyclononyl, cyclodecyl, cycloundecyl, and cyclododecyl; preference is given to cyclopentyl, cyclohexyl, and cycloheptyl.

Each of the radicals R in Al(OR)₃ or Ti(OR)₄ is preferably identical and selected from isopropyl or 2-ethylhexyl.

Examples of preferred acidic organometallic catalysts are selected from dialkyltin oxides R₂SnO, where R is defined as above. A particularly preferred representative compound for acidic organometallic catalysts is di-n-butyltin oxide, which is commercially available as “oxo-tin”, or di-n-butyltin dilaurate.

Preferred acidic organic catalysts are acidic organic compounds having, by way of example, phosphate groups, sulfonic acid groups, sulfate groups, or phosphonic acid groups. Particular preference is given to sulfonic acids, such as para-toluenesulfonic acid. Acidic ion exchangers may also be used as acidic organic catalysts, e.g. polystyrene resins comprising sulfonic acid groups and crosslinked with about 2 mol % of divinylbenzene.

It is also possible to use combinations of two or more of the abovementioned catalysts. It is also possible to use an immobilized form of those organic or organometallic, or else inorganic catalysts which take the form of discrete molecules.

If the intention is to use acidic inorganic, organometallic, or organic catalysts, according to the invention the amount used is from 0.1 to 10% by weight, preferably from 0.2 to 2% by weight, of catalyst.

The process to prepare (D2) is carried out under inert gas, e.g. under carbon dioxide, nitrogen, or a noble gas, among which mention may particularly be made of argon.

The process is generally carried out at temperatures of from 60 to 200° C. It is preferable to operate at temperatures of from 130 to 180° C., in particular up to 150° C., or below that temperature. Maximum temperatures up to 145° C. are particularly preferred, and temperatures up to 135° C. are very particularly preferred.

The pressure conditions for the process are not critical per se. It is possible to operate at markedly reduced pressure, e.g. at from 10 to 500 mbar. The inventive process may also be carried out at pressures above 500 mbar. A reaction at atmospheric pressure is preferred for reasons of simplicity; however, conduct at slightly increased pressure is also possible, e.g. up to 1200 mbar. It is also possible to operate at markedly increased pressure, e.g. at pressures up to 10 bar. Reaction at atmospheric pressure is preferred.

The reaction time for the process is usually from 10 minutes to 25 hours, preferably from 30 minutes to 10 hours, and particularly preferably from one to 8 hours.

Once the reaction has ended, the high-functionality hyperbranched polyesters can easily be isolated, e.g. by removing the catalyst by filtration and concentrating the mixture, the concentration process here usually being carried out at reduced pressure. Other work-up methods with good suitability are precipitation after addition of water, followed by washing and drying.

Component (D2) can also be prepared in the presence of enzymes or decomposition products of enzymes (according to DE-A 101 63163). For the purposes of the present invention, the term acidic organic catalysts does not include the dicarboxylic acids reacted according to the invention.

It is preferable to use lipases or esterases. Lipases and esterases with good suitability are Candida cylindracea, Candida lipolytica, Candida rugosa, Candida antarctica, Candida utilis, Chromobacterium viscosum, Geolrichum viscosum, Geotrichum candidum, Mucor javanicus, Mucor mihei, pig pancreas, pseudomonas spp., pseudomonas fluorescens, Pseudomonas cepacia, Rhizopus arrhizus, Rhizopus delemar, Rhizopus niveus, Rhizopus oryzae, Aspergillus niger, Penicillium roquefortii, Penicillium camembertii, or esterase from Bacillus spp. and Bacillus thermoglucosidasius. Candida antarctica lipase B is particularly preferred. The enzymes listed are commercially available, for example from Novozymes Biotech Inc., Denmark.

The enzyme is preferably used in immobilized form, for example on silica gel or Lewatit®. The processes for immobilizing enzymes are known per se, e.g. from Kurt Faber, “Biotransformations in organic chemistry”, 3rd edition 1997, Springer Verlag, Chapter 3.2 “Immobilization” pp. 345-356. Immobilized enzymes are commercially available, for example from Novozymes Biotech Inc., Denmark.

The amount of immobilized enzyme used is from 0.1 to 20% by weight, in particular from 10 to 15% by weight, based on the total weight of the starting materials used and to be reacted.

When enzymes are used, the process is usually carried out at temperatures above 60° C. It is preferable to operate at temperatures of 100° C. or below that temperature. Preference is given to temperatures up to 80° C., very particular preference is given to temperatures of from 62 to 75° C., and still more preference is given to temperatures of from 65 to 75° C.

The process is carried out in the presence of a solvent. Examples of suitable compounds are hydrocarbons, such as paraffins or aromatics. Particularly suitable paraffins are n-heptane and cyclohexane. Particularly suitable aromatics are toluene, ortho-xylene, meta-xylene, para-xylene, xylene in the form of an isomer mixture, ethylbenzene, chlorobenzene and ortho- and meta-dichlorobenzene. Other very particularly suitable solvents are: ethers, such as dioxane or tetrahydrofuran, and ketones, such as methyl ethyl ketone and methyl isobutyl ketone.

The amount of solvent added is at least 5 parts by weight, based on the weight of the starting materials used and to be reacted, preferably at least 50 parts by weight, and particularly preferably at least 100 parts by weight. Amounts of more than 10 000 parts by weight of solvent are undesirable, because the reaction rate decreases markedly at markedly lower concentrations, giving uneconomically long reaction times.

The process is carried out at pressures above 500 mbar. Preference is given to the reaction at atmospheric pressure or slightly increased pressure, for example at up to 1200 mbar. It is also possible to operate under markedly increased pressure, for example at pressures up to 10 bar. The reaction at atmospheric pressure is preferred.

The reaction time for the enzyme-catalyzed process is usually from 4 hours to 6 days, preferably from 5 hours to 5 days, and particularly preferably from 8 hours to 4 days.

Once the reaction has ended, the high-functionality hyperbranched polyesters can be isolated, e.g. by removing the enzyme by filtration and concentrating the mixture, the concentration process here usually being carried out at reduced pressure. Other work-up methods with good suitability are precipitation after addition of water, followed by washing and drying.

The high-functionality, hyperbranched polyesters (D2) obtainable by the inventive process feature particularly low contents of discolored and resinified material.

The inventive polyesters (D2) have a molar mass M_{w} of from 500 to 50 000 g/mol, preferably from 1000 to 20 000 g/mol, particularly preferably from 1000 to 19 000 g/mol. The polydispersity is from 1.2 to 50, preferably from 1.4 to 40, particularly preferably from 1.5 to 30, and very particularly preferably from 1.5 to 10. They are usually very soluble, i.e. clear solutions can be prepared using up to 50% by weight, in some cases even up to 80% by weight, of the inventive polyesters in tetrahydrofuran (THF), n-butyl acetate, ethanol, and numerous other solvents, with no gel particles detectable by the naked eye.

The inventive high-functionality hyperbranched polyesters (D2) are carboxy-terminated, carboxy- and hydroxy-terminated, and preferably hydroxy-terminated.

Component (E)

Conventional additives (E) which may be used are any of the substances which have good solubility in components (A), (B), (C) and D, or have good miscibility with these. Examples of suitable additives are dyes, stabilizers, lubricants, and antistatic agents. These additives and their preparation are known to the person skilled in the art and are described in the literature.

The inventive molding compositions are prepared from components (A), (B), (C), (D), and, if desired, (E) by the process known to the person skilled in the art, e.g. via mixing of the components in the melt, using apparatus known to the person skilled in the art at temperatures in the range from 200 to 300° C., in particular from 200 to 280° C. Each of the components may be introduced in pure form into the mixing apparatus. However, it is also possible to begin by premixing individual components, for example (A) and (B) and then to mix these with the other components, such as (C), (D), and, if appropriate, (E). It is preferable to begin by preparing a concentrate of component (D) in one of the components (A) or (B), or in a mixture of components (A) and (B) (these being known as additive masterbatches), and then to mix with the desired amounts of the remaining components.

The inventive thermoplastic molding compositions can be used in the process known to the person skilled in the art to produce moldings, fibers, foil, or foams. Injection molding or blown molding may preferably be used to produce moldings. However, the thermoplastic molding compositions may also be pressed, calendered, extruded, or vacuum-formed.

A particular feature of the inventive thermoplastic molding compositions is improved flowability with, in other respects, comparably good mechanical and optical properties.

According to the invention, the highly branched or hyperbranched polymers which are used as component (D) in the inventive thermoplastic molding compositions are suitable mold-release agents for, in principle, any thermoplastic molding composition.

They are preferably suitable mold-release agents for thermoplastic molding compositions comprising hard methyl methacrylate polymers, hard vinylaromatic-vinyl cyamide polymers, and soft graft copolymers comprising an elastomeric graft core.

### EXAMPLES

In each of the following inventive examples and in each of the comparative examples, thermoplastic molding compositions are prepared and the following properties are determined:

Swelling Index SI [Dimensionless]:

The swelling index SI of the graft-core polymer (C1) was measured on foils obtained via overnight drying, at 50° C. and from 700 to 800 mbar, of the dispersion produced during the preparation, described below, of the rubber cores (C1).

A piece of each foil was treated with toluene. After 24 hours, the liquid was decanted and the swollen film was weighed. The swollen film was dried in vacuo at up to 120° C. to constant weight and again weighed. The swelling index is the quotient calculated from the weight of the swollen film and the weight of the dried film.

Impact Resistance aₙ [kJ/m²]:

Impact resistance an was determined to ISO 179-2/1 eU at 23° C.

Notched Impact Resistance aₖ [kJ/m²]:

Notched impact resistance aₖ was determined to ISO 179-2/1 eA(F) at 23° C.

Puncture Resistance PR [Nm]:

Puncture resistance PR was determined to ISO 6603-2/40/20/C at 23° C. on sheets of thickness 2 mm.

Flowability MVR [ml/10 min]:

Melt volume rate MVR 220/10 to DIN EN ISO 1133 was determined as a measure of flowability.

Vicat B50 Heat Distortion Temperature [° C.]:

Vicat B50 heat distortion temperature was determined to ISO 306: 1994.

Demolding Force [N]:

Demolding force was determined on an Arburg Allrounder 270 E/16 injection-molding machine with screw diameter of 18 mm. The injection mold used was a demolding sleeve, which is a cylindrical component with base, demolded centrally by an ejector in the basal region. The force is measured by way of a dynamometer attached to the ejector. The dimensions of the cylindrical demolding sleeve are as follows: volume 1 cm³, diameter 14 mm, height 14 mm, wall thickness 1 mm, gate type: tunnel.

The Process Conditions Set were as Follows:

Screw rotation rate: 10 rpm; screw advance speed: 60 mm/sec; injection time: 0.45 sec; injection pressure: 750 bar; hold pressure time: 3 sec; hold pressure: 200 bar; backpressure: 50 bar; plasticizing time: 1.7 sec; cooling time: 22 sec; injection temperature: 250° C.; demolding temperature: 60° C.

Melt Viscosity [Pa s]

Melt viscosity was determined using a Göttfert high-pressure capillary rheometer (Rheograph 2003). The length/radius ratio for the die was 60, the radius being 0.5 mm. Measurement temperatures were 220° C. and 250° C. Measurement time and preheat time were 5 min. The specimens were predried in vacuo at 80° C. for 4 hours. Viscosity and shear rate are apparent values, because no correction was made with regard to inlet pressure loss and pseudoplasticity. Shear rate and viscosity were determined as apparent values using the following equations. Shear rate and shear stress relate to the die wall.

Apparent Wall Shear Rate:

$$D = \frac{4 \dot{V}}{π {R}^{3}}$$

Apparent Wall Shear Stress:

$$τ = \frac{p}{2 ( L / R )}$$

Apparent Viscosity:

$$η = \frac{τ}{D} = \frac{π {R}^{4} p}{8 \dot{V} L}$$

where p=extrusion pressure, R=die radius, L=die length, V dot=volume throughput

Transmittance [%]:

Transmittance was determined to DIN 53236 on sheets of thickness 2 mm.

Yellowness Index YI [Dimensionless]:

Yellowness index (yellow tinge) was determined to ASTM D 1925-70 C/10°.

Particle Size D₅₀ [m]:

Average particle size and particle size distribution for the graft copolymer cores (C1) were determined from the cumulative weight distribution. The average particle sizes are in all cases the weight average of the particle sizes. The determination of these is based on the method of W. Scholtan and H. Lange, Kolloid-Z, und Z.-Polymere 250 (1972), pp. 782-796, using an analytical ultracentrifuge. The ultracentrifuge measurement gives the cumulative weight distribution of the particle diameter of a specimen. From this it is possible to deduce what percentage by weight of the particles have diameter identical to or smaller than a particular size. The average particle diameter, which is also termed the D₅₀ value of the cumulative weight distribution, is defined here as that particle diameter at which 50% by weight of the particles have diameter smaller than that corresponding to the D₅₀ value. Equally, 50% by weight of the particles then have diameter larger than the D₅₀ value.

Starting Materials:

The component A used comprised a copolymer composed of 95.5% by weight of methyl methacrylate and 4.5% by weight of methyl acrylate with a viscosity number VN of 70 ml/g (determined on 0.5% strength by weight solution in dimethylformamide at 23° C. to DIN 53727).

The component B used comprised 81% by weight of styrene and 19% by weight of acrylonitrile with a viscosity number VN of 60 ml/g (determined on 0.5% strength by weight solution in dimethylformamide at 23° C. to DIN 53727).

Components C were Prepared as Follows:

In a first stage, graft cores C1 were prepared by, in each case, taking a solution composed of 186 parts by weight of water, 0.36 part by weight of sodium bicarbonate, 0.30 part by weight of potassium peroxodisulfate, and 0.55 part by weight of potassium stearate and using nitrogen to inertize the mixture, and controlling its temperature to 70° C. A mixture composed of 1 part by weight of tert-dodecyl mercaptan and 100 parts by weight of a mixture composed of 73% by weight of butadiene and 27% by weight of styrene (% by weight based in each case on the total weight of butadiene and styrene) was then added within a period of 5 h, with stirring. The mixture was polymerized to at least 95% conversion.

The resultant graft cores C1 had an average particle diameter D₅₀ of 130 nm and a swelling index SI of 23.

Each of the reaction mixtures obtained in the first stage and comprising the graft cores C1 was used to prepare the graft polymers C via two-stage graft copolymerization in the manner described below.

The Abbreviations Used Here were:

| | |
|---|---|
| S | Styrene |
| MMA | Methyl methacrylate |
| DCPA | Dihydrodicyclopentadienyl acrylate |
| BA | Butyl acrylate |

A reaction mixture obtained in the first stage comprising 80 parts by weight of graft cores C1 was used as initial charge and inertized with nitrogen. In each case, 0.1 part by weight of potassium stearate and 0.04 part by weight of potassium peroxodisulfate in 10 parts by weight of water were then added. In each case, this mixture was treated at 70° C. within a period of 1.5 h with 10 parts by weight of a mixture of the monomers of which the first graft shell C2 was composed, this latter mixture being composed of 32.7 parts by weight of S, 65.3 parts by weight of MMA, and 2 parts by weight of DCPA. Once the feed had ended, the polymerization process to construct the first graft shell C2 was continued for 15 min.

In each case, 10 parts by weight of a mixture of the monomers of which the second graft shell C3 was composed was added within a period of 1.5 h to the resultant reaction mixtures, the added mixture in each case being composed of 85 parts by weight of MMA and 15 parts by weight of BA. The polymerization process to construct the second graft shell C3 was then continued for 60 minutes. In each case, a further 0.04 part by weight of potassium peroxodisulfate in 10 parts by weight of water was then added and the polymerization process was continued for 1.5 h.

The resultant graft polymer C was then isolated via precipitation using a 1% strength by weight magnesium sulfate solution, washed with water, and filtered. The residual moisture level was 21.1% by weight based on the total weight of the graft copolymer.

Components D were Prepared as Follows:

Hyperbranched Polycarbonate (D1)

1 mol of the polyhydric alcohol was mixed with 1 mol of diethyl carbonate in a three-necked flask equipped with stirrer, reflux condenser, and internal thermometer (as in table 1), and 250 ppm, based on the alcohol, of K₂CO₃ (example D1-a) and, respectively, KOH (example D1-b) were added as catalyst. The mixture was then heated to 140° C., with stirring, and stirred at this temperature for 2 hours. As the reaction time proceeded, the temperature of this reaction mixture reduced as a result of onset of evaporative cooling by the monoalcohol liberated. The reflux condenser was then replaced by an inclined condenser, ethanol was removed by distillation, and the temperature of the reaction mixture was increased slowly to 180° C.

The ethanol removed by distillation was collected in a cooled round-bottomed flask and weighed, and conversion was thus determined and compared in percentage terms with the complete conversion theoretically possible. (See table 1.)

The molecular weight of the reaction product was determined as follows: weight average Mw and number average Mn were determined via gel permeation chromatography at 20° C., using four columns arranged in series (2×1000 Å, 2×10 000 Å), each column being Phenomenex PL-Gel, 600×7.8 mm; eluent dimethyl-acetamide, 0.7 ml/min, standard polymethyl methacrylate.

TABLE 1
Hyperbranched polycarbonate D1
(TMP is trimethylolpropane, Glyc is glycerol, EO is ethylene oxide,
PO is propylene oxide, and nd is not determined)

| Example | D1-a | D1-b |
|---|---|---|
| Alcohol | Glyc × 7.5 PO | TMP × 3.0 EO |
| Alcohol¹⁾ removed by | 75 | 91 |
| distillation | | |
| [mol %] | | |
| Molecular weight Mw | 4400 | 8600 |
| [g/mol] | | |
| Molecular weight Mn | 2000 | 3400 |
| [g/mol] | | |
| Viscosity (23° C.) | 2500 | 26 000 |
| [mPa s] | | |
| OH number (mg | 177 | 261 |
| KOH/g) | | |

¹⁾Amount of alcohol based on complete conversion

Joncryle ADF-1351 from Johnson Polymer was used as a known flow improver D1-C1 (for comparison).

Calcium stearate (Ceasit AV from Baerlocher) was used as a mold-release agent D1-C2 (for comparison).

Preparation of Molding Compositions and Production of Test Specimens:

Using a twin-screw extruder (Werner & Pfleiderer ZSK30), the parts by weight of component A given in table 2 were dewatered and mixed in the melt, and homogenized, with the parts by weight likewise given in table 2 of components B, C, and D, at 250° C. with a total throughput of 1000 g/h. After pelletization and drying, the resultant thermoplastic molding compositions 1-2 and the molding compositions c1-c3 serving for comparison were used for injection molding of test specimens, which were tested. The test results are likewise given in table 2.

TABLE 2

| | Molding composition** | | | | |
|---|---|---|---|---|---|
| | 1 | 2 | c1 | c2 | c3 |
| Starting materials | pts. by wt. | pts. by wt. | pts. by wt. | pts. by wt. | pts. by wt. |
| A | 35.4 | 35.4 | 36.2 | 35.4 | 36.1 |
| B | 34.4 | 34.4 | 35.1 | 34.4 | 35.0 |
| C* | 28.2 | 28.2 | 28.7 | 28.2 | 28.7 |
| D1-a | 2.0 | — | — | — | — |
| D1-b | — | 2.0 | — | — | — |
| D1-c1 | — | — | — | 2.0 | — |
| D1-c2 | — | — | — | — | 0.2 |
| Test results | | | | | |
| aₙ [kJ/m²] | 155.0 | 118.0 | 145.0 | 162.0 | 147.0 |
| aₖ [kJ/m²] | 17.3 | 12.9 | 15.5 | 12.4 | 15.6 |
| Puncture resistance PR [Nm] | 23.7 | 18.3 | 25.0 | 21.2 | 22.6 |
| MVR [ml/10 min] | 17.7 | 21.7 | 13.7 | 16.1 | 14.2 |
| Melt viscosity (220° C.) [Pa s]*** | 196.5 | 190.5 | 219.8 | 208.5 | 214.9 |
| Melt viscosity (250° C.) [Pa s]*** | 129.0 | 121.2 | 143.5 | 139.9 | 140.4 |
| Vicat B50 [° C.] | 85.3 | 91.2 | 91.9 | 87.9 | 92.2 |
| Demolding force [N] | 80.8 | 99.3 | 120.9 | 134.6 | 105.2 |
| Transmittance [%] | 89.7 | 92.0 | 92.6 | 92.9 | 92.5 |
| Yellowness YI | 19.8 | 9.4 | 11.0 | 10.4 | 10.9 |

*Component C was used with residual moisture, the amounts given being based on dry weight
**Molding compositions indicated by c are non-inventive and serve for comparison
***Determined at shear rate 1152 s⁻¹.

The examples confirm improved flowability with comparable mechanical and optical properties and easier demolding of the inventive thermoplastic molding compositions in comparison with known molding compositions.

1-15. (canceled)

16. A thermoplastic molding composition comprising a mixture, the mixture comprising a component (A), a component (B), a component (C) and a component (D):
wherein the component (A) comprises a methyl methacrylate polymer prepared by polymerizing component (A) reactants comprising (A1) from 90 to 100% by weight methyl methacrylate, based on component (A), and (A2) from 0 to 10% by weight of a C₁-C₈-alkyl acrylate, based on component (A), and the component (A) is present in the mixture in an amount of 30 to 68.99% by weight, based on the total weight of the components (A), (B), (C), and (D);
wherein the component (B) comprises a copolymer prepared by polymerizing component (B) reactants comprising (B1) from 75 to 88% by weight, based on component (B), of a vinylaromatic monomer, and (B2) from 12 to 25% by weight, based on component (B), of a vinyl cyamide, and the component (B) is present in the mixture in an amount of 30 to 68.99% by weight, based on the total weight of the components (A), (B), (C), and (D);
wherein the component (C) comprises a graft copolymer prepared by copolymerizing:
(C1) from 60 to 90% by weight, based on component (C), of a core obtained by polymerizing a first monomer mixture, comprising (C11) from 65 to 90% by weight, based on (C1), of a 1,3-diene, and (C12) from 10 to 35% by weight, based on (C1), of a vinylaromatic monomer, and
(C2) from 5 to 20% by weight, based on component (C), of a first graft shell, obtained by polymerizing a second monomer mixture, comprising (C21) from 30 to 60% by weight, based on (C2), of a vinylaromatic monomer, (C22) from 40 to 70% by weight, based on (C2), of a C₁-C₈-alkyl methacrylate, and (C23) from 0 to 3% by weight, based on (C2), of a crosslinking monomer, and
(C3) from 5 to 20% by weight, based on component (C), of a second graft shell, obtained by polymerizing a third monomer mixture, comprising (C31) from 70 to 98% by weight, based on (C3), of a C₁-C₈-alkyl methacrylate, and (C32) from 2 to 30% by weight, based on (C3), of a C₁-C₈-alkyl acrylate,
with the proviso that the ratio by weight of (C2) to (C3) is 2:1 to 1:2, and the component (C) is present in the mixture in an amount of 1 to 39.99% by weight, based on the total weight of the components (A), (B), (C), and (D), and
wherein the component (D) comprises at least one highly branched or hyperbranched polymer selected from the group consisting of (D1) highly branched or hyperbranched polycarbonates, (D2) highly branched or hyperbranched polyesters of Aₓ+B_{y} type, where x is at least 1.1 and y is at least 2.1, and mixtures thereof, and the component (D) is present in the mixture in an amount of 0.01 to 39% by weight, based on the total weight of the components (A), (B), (C), and (D).

17. The thermoplastic molding composition according to claim 16, wherein the component (D) comprises a highly branched or hyperbranched polycarbonate having a number-average molar mass Mₙ of 100 to 15 000 g/mol.

18. The thermoplastic molding composition according to claim 16, wherein the component (D) comprises a highly branched or hyperbranched polycarbonate having a glass transition temperature Tg of from −80° C. to 140° C.

19. The thermoplastic molding composition according to claim 17, wherein the highly branched or hyperbranched polycarbonate has a glass transition temperature Tg of from −80° C. to 140° C.

20. The thermoplastic molding composition according to claim 16, wherein the component (D) comprises a highly branched or hyperbranched polycarbonate having a viscosity at 23° C. of 50 to 200,000 mPa·s.

21. The thermoplastic molding composition according to claim 19, wherein the highly branched or hyperbranched polycarbonate has a viscosity at 23° C. of 50 to 200,000 mPa·s.

22. The thermoplastic molding composition according to claim 16, wherein the component (D) comprises a highly branched or hyperbranched polycarbonate prepared by a process comprising:
(a) reacting at least one organic carbonate of the general formula RO(CO)OR with at least one aliphatic alcohol to form one or more condensates, wherein each R independently represents a straight or branched aliphatic, araliphatic or aromatic hydrocarbon radical having 1 to 20 carbon atoms, and wherein the quantitative proportion of OH groups in the at least one aliphatic alcohol to the carbonate groups in the at least one organic carbonate is selected such that the one or more condensates have an average of either one carbonate group and more than one OH group or one OH group and more than one carbonate group; and
(b) intermolecularly reacting the one or more condensates to form a high-functionality, highly branched or hyperbranched polycarbonate.

23. The thermoplastic molding composition according to claim 16, wherein the component (D) comprises a highly branched or hyperbranched polyester of the Aₓ+B_{y} type, where x is at least 1.1 and y is at least 2.1 having a number-average molar mass Mₙ of from 300 to 30,000 g/mol.

24. The thermoplastic molding composition according to claim 16, wherein the component (D) comprises a highly branched or hyperbranched polyester of the Aₓ+B_{y} type, where x is at least 1.1 and y is at least 2.1 having a glass transition temperature T_{g} of from −50° C. to 140° C.

25. The thermoplastic molding composition according to claim 23, wherein the highly branched or hyperbranched polyester has a glass transition temperature T_{g} of from −50° C. to 140° C.

26. The thermoplastic molding composition according to claim 16, wherein the component (D) comprises a highly branched or hyperbranched polyester of the Aₓ+B_{y} type, where x is at least 1.1 and y is at least 2.1 having an OH number of 0 to 600 mg KOH/g of polyester.

27. The thermoplastic molding composition according to claim 25, wherein the highly branched or hyperbranched polyester has an OH number of 0 to 600 mg KOH/g of polyester.

28. The thermoplastic molding composition according to claim 16, wherein the component (D) comprises a highly branched or hyperbranched polyester of the Aₓ+B_{y} type, where x is at least 1.1 and y is at least 2.1 having a COOH number of 0 to 600 mg KOH/g of polyester.

29. The thermoplastic molding composition according to claim 25, wherein the highly branched or hyperbranched polyester has a COOH number of 0 to 600 mg KOH/g of polyester.

30. The thermoplastic molding composition according to claim 16, wherein the component (D) comprises a highly branched or hyperbranched polyester of the Aₓ+B_{y} type, where x is at least 1.1 and y is at least 2.1, wherein at least one of an OH number or a COOH number for the highly branched or hyperbranched polyester is greater than zero.

31. The thermoplastic molding composition according to claim 16, wherein the component (D) comprises a highly branched or hyperbranched polyester of the Aₓ+B_{y} type, where x is at least 1.1 and y is at least 2.1 prepared by at least one reaction selected from the group consisting of reacting one or more dicarboxylic acids or derivatives thereof with one or more at least trihydric alcohols, and reacting one or more at least tricarboxylic acids or derivatives thereof with one or more diols.

32. A process comprising mixing a component (A), a component (B), a component (C) and a component (D) in the melt phase:
wherein the component (A) comprises a methyl methacrylate polymer prepared by polymerizing component (A) reactants comprising (A1) from 90 to 100% by weight methyl methacrylate, based on component (A), and (A2) from 0 to 10% by weight of a C₁-C₈-alkyl acrylate, based on component (A), and the component (A) is present in the mixture in an amount of 30 to 68.99% by weight, based on the total weight of the components (A), (B), (C), and (D);
wherein the component (B) comprises a copolymer prepared by polymerizing component (B) reactants comprising (B1) from 75 to 88% by weight, based on component (B), of a vinylaromatic monomer, and (B2) from 12 to 25% by weight, based on component (B), of a vinyl cyamide, and the component (B) is present in the mixture in an amount of 30 to 68.99% by weight, based on the total weight of the components (A), (B), (C), and (D);
wherein the component (C) comprises a graft copolymer prepared by copolymerizing:
(C1) from 60 to 90% by weight, based on component (C), of a core obtained by polymerizing a first monomer mixture, comprising (C11) from 65 to 90% by weight, based on (C1), of a 1,3-diene, and (C12) from 10 to 35% by weight, based on (C1), of a vinylaromatic monomer, and
(C2) from 5 to 20% by weight, based on component (C), of a first graft shell, obtained by polymerizing a second monomer mixture, comprising (C21) from 30 to 60% by weight, based on (C2), of a vinylaromatic monomer, (C22) from 40 to 70% by weight, based on (C2), of a C₁-C₈-alkyl methacrylate, and (C23) from 0 to 3% by weight, based on (C2), of a crosslinking monomer, and
(C3) from 5 to 20% by weight, based on component (C), of a second graft shell, obtained by polymerizing a third monomer mixture, comprising (C31) from 70 to 98% by weight, based on (C3), of a C₁-C₈-alkyl methacrylate, and (C32) from 2 to 30% by weight, based on (C3), of a C₁-C₈-alkyl acrylate,
with the proviso that the ratio by weight of (C2) to (C3) is 2:1 to 1:2, and the component (C) is present in the mixture in an amount of 1 to 39.99% by weight, based on the total weight of the components (A), (B), (C), and (D), and
wherein the component (D) comprises at least one highly branched or hyperbranched polymer selected from the group consisting of (D1) highly branched or hyperbranched polycarbonates, (D2) highly branched or hyperbranched polyesters of Aₓ+B_{y} type, where x is at least 1.1 and y is at least 2.1, and mixtures thereof, and the component (D) is present in the mixture in an amount of 0.01 to 39% by weight, based on the total weight of the components (A), (B), (C), and (D).

33. An article comprising a thermoplastic molding composition according to claim 16, wherein the article is selected from the group consisting of moldings, fibers, foil, foams and combinations thereof.

34. A mold-release agent comprising at least one highly branched or hyperbranched polymer selected from the group consisting of: highly branched or hyperbranched polycarbonates; highly branched or hyperbranched polyesters of Aₓ+B_{y} type, where x is at least 1.1 and y is at least 2.1; and mixtures thereof.
